(19) United States
(12) Patent Application Publication
(10) Pub. No.: US 2024/0397248 A1
(43) Pub. Date: Nov. 28, 2024

(54) ELECTRONIC DEVICE INCLUDING SENSOR MODULE

(71) Applicant: Samsung Electronics Co., Ltd., Suwon-si (KR)

(72) Inventors: Sungjin KIM, Suwon-si (KR); Sohee KIM, Suwon-si (KR); Haekeu PARK, Suwon-si (KR); Juhee CHANG, Suwon-si (KR); Hyeonyeong JEONG, Suwon-si (KR)

(21) Appl. No.: 18/795,714

(22) Filed: Aug. 6, 2024

Related U.S. Application Data
(63) Continuation of application No. PCT/KR2023/001479, filed on Feb. 1, 2023.

(30) Foreign Application Priority Data
Feb. 7, 2022 (KR) 10-2022-0015679
Apr. 7, 2022 (KR) 10-2022-0043222

(51) Int. Cl. H04R 1/10; H04R 29/00

(52) U.S. Cl. CPC H04R 1/1041; H04R 1/1016; H04R 29/001; H04R 2420/07

(57) ABSTRACT

An electronic device is provided. The electronic device includes a cradle including a mounting area configured such that a sound output device with a sound output portion at one side thereof is detachably mounted, and a detection area, a circuit board disposed within the cradle and including a processor configured to control the sound output device, and a sensor module disposed adjacent to the detection area and electrically connected to the processor, wherein the sound output portion is fabricated in at least one of a first type or a second type, wherein a sensor module is configured to transmit, to the processor, sensing information reflecting at least one of a contact state between the sound output portion and the sensor module based on the at least one of the first type or the second type of the sound output portion, an adjacent state between the sound output portion and the sensor module, or a state related to the at least one of the first type or the second type of the sound output portion, and wherein the processor is configured to transmit, based on the sensing information, a signal related to sound configuration for adjusting sound output configuration of the sound output device, to the sound output device.

### CROSS-REFERENCE TO RELATED APPLICATION(S)

This application is a continuation application, claiming priority under § 365 (c), of an International application No. PCT/KR2023/001479, filed on Feb. 1, 2023, which is based on and claims the benefit of a Korean patent application number 10-2022-0015679, filed on Feb. 7, 2022, in the Korean Intellectual Property Office, and of a Korean patent application number 10-2022-0043222, filed on Apr. 7, 2022, in the Korean Intellectual Property Office, the disclosure of each of which is incorporated by reference herein in its entirety.

### BACKGROUND

### 1. Field

The disclosure relates to an electronic device including a sensor module.

### 2. Description of Related Art

The term “electronic device” may mean a device that performs a function according to a program provided therein (e.g., an electronic scheduler, a portable multimedia player, a mobile communication terminal, a tablet personal computer (PC), an image/sound device, a desktop/laptop PC, or a vehicle navigation system), as well as a home appliance. For example, these electronic devices may output information stored therein as sound or an image. With the increase of degree of integration of electronic devices and the generalization of ultra-high-speed and high-capacity wireless communication, recently, various functions are capable of being installed in a single electronic device, such as a mobile communication terminal. For example, in addition to communication functions, entertainment functions such as games, multimedia functions such as music/video playback, communication and security functions for mobile banking, and functions such as schedule management or electronic wallet, are being integrated into a single electronic device. These electronic devices are being miniaturized to be conveniently carried by users. With the development of electronic and communication technology, electronic devices have been reduced in size and weight, so that the electronic devices can be used without inconvenience even in the state in which the electronic devices are worn on a body.

The above information is presented as background information only to assist with an understanding of the disclosure. No determination has been made, and no assertion is made, as to whether any of the above might be applicable as prior art with regard to the disclosure.

### SUMMARY

An electronic device that is wearable on a body may include one or more components related to sound effect. For example, a wearable electronic device including a speaker and a microphone may be worn on a portion close to a user's ear like an in-ear earphone (or an earset) or a hearing aid.

In a wearable electronic device, a device for sound output (e.g., an earset) may be fabricated in various types depending on user needs. For example, an earset may be classified into a canal-type earset configured to block ambient noise and to increase immersion in sound or an open-type earset configured to provide a more comfortable fit. In addition, the canal-type earset and the open-type earset may differ from each other in sound output configuration so as to provide optimal sound quality to a user.

In some cases, users may use a canal-type earset and an open-type earset interchangeably. In such a case, it is necessary to automatically determine the type of earset and change sound output configuration more conveniently.

Aspects of the disclosure are to address at least the above-mentioned problems and/or disadvantages and to provide at least the advantages described below. Accordingly, an aspect of the disclosure is to provide an output portion of a sound output device that is identified and a sound parameter of the sound output device that is configured.

Additional aspects will be set forth in part in the description which follows and, in part, will be apparent from the description, or may be learned by practice of the presented embodiments.

In accordance with an aspect of the disclosure, a sound output device is provided. The sound output device includes a housing including a sound output portion and defining the exterior of the audio output device, a contact portion disposed in the housing and electrically connected to the cradle, and a circuit board disposed within the housing and including a processor configured to control the sound output device. The sound output portion is fabricated in at least one of a first type and a second type, and the processor is configured to receive a sound configuration signal corresponding to at least one of the first type or the second type from the cradle to change the sound output configuration of the sound output device.

In accordance with another aspect of the disclosure, a method for controlling a cradle configured to accommodate a sound output device is provided. The method includes determining whether the sound output device is placed within a mounting area, identifying a type of an output portion provided in at least a portion of the sound output device, wherein the sound output portion has at least one of a first type or a second type, selecting a sound configuration signal corresponding to the identified type of the sound output portion, and transmitting the selected sound configuration signal to the sound output device so as to control sound output configuration of the sound output module.

In accordance with another aspect of the disclosure, an electronic device is provided. The electronic device includes a cradle including a mounting area configured such that a sound output device with a sound output portion at one side is detachably mounted, and a detection area, a circuit board disposed within the cradle and including a processor configured to control the sound output device, and a sensor module disposed adjacent to the detection area and electrically connected to the processor, wherein the sound output portion is fabricated in at least one of a first type or a second type, wherein the sensor module is configured to transmit, to the processor, sensing information reflecting at least one of a contact state between the sound output portion and the sensor module based on the at least one of the first type or the second type of the sound output portion, an adjacent state between the sound output portion and the sensor module, or a state related to the at least one of the first type or the second type of the sound output portion, and wherein the processor is configured to transmit, based on the sensing information, a sound configuration signal for adjusting sound output configuration of the sound output device, to the sound output device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include determining whether a sound output device is placed within a mounting area, identifying a type of a sound output portion provided in at least a portion of the sound output device, wherein the sound output portion has at least one of a first type or a second type, selecting a sound configuration signal corresponding to the identified type of the sound output portion, and transmitting the selected sound configuration signal to the sound output device so as to control sound output configuration of the sound output device.

In an electronic device according to various embodiments of the disclosure, the type of a sound output device or the specification of an ear tip mounted on the sound output device can be determined by using a sensor module, and configuration of the sound output device can be changed correspondingly.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 a block diagram of an electronic device in a network environment according to an embodiment of the disclosure;

FIG. 2 is a block diagram of an audio module according to an embodiment of the disclosure;

FIG. 3 is a view illustrating an implementation example of an electronic device according to an embodiment of the disclosure;

FIG. 4 is a side view of a sound output device according to an embodiment of the disclosure;

FIG. 5 is a top view of the sound output device according to an embodiment of the disclosure;

FIG. 6 is a view illustrating an example of first type sound output devices according to an embodiment of the disclosure;

FIG. 7 is a view illustrating an example of first type sound output devices according to an embodiment of the disclosure;

FIG. 8 is a view illustrating an example of second type sound output devices according to an embodiment of the disclosure;

FIG. 9 is a view illustrating a sound output device disposed in a cradle according to an embodiment of the disclosure;

FIG. 10 is a cross-sectional view illustrating various types of sound output devices disposed in the cradle according to an embodiment of the disclosure;

FIG. 11 is a view illustrating an implementation example of a sensor module according to an embodiment of the disclosure;

FIG. 12 is a view illustrating a cradle according to an embodiment of the disclosure;

FIG. 13A is a view illustrating an implementation example of the sensor module according to an embodiment of the disclosure;

FIG. 13B is a view illustrating another implementation example of the sensor module according to an embodiment of the disclosure;

FIG. 13C is a view illustrating another implementation example of the sensor module according to an embodiment of the disclosure;

FIG. 13D is a view illustrating another implementation example of the sensor module according to an embodiment of the disclosure;

FIG. 14 is a view illustrating a sound output device disposed in a cradle according to an embodiment of the disclosure;

FIG. 15 is a diagram showing the frequency characteristics of sound measured in the detection area depending on the types of sound output devices according to an embodiment of the disclosure;

FIG. 16 is a flowchart illustrating a method of controlling sound output configuration of a sound output device by an electronic device according to an embodiment of the disclosure; and

FIG. 17 is a flowchart illustrating a method of controlling configuration of a sound output device by a cradle according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

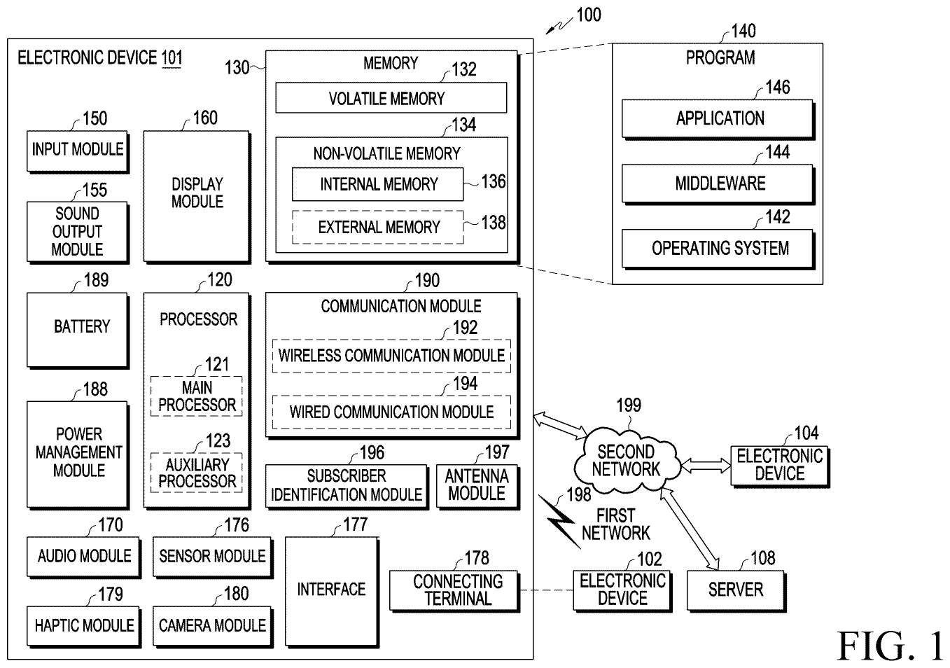

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

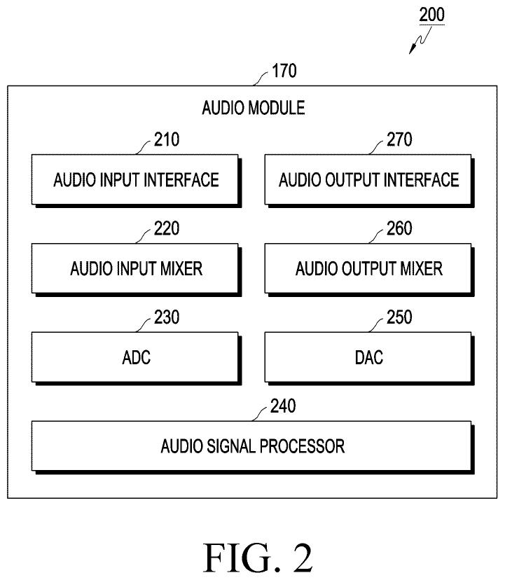

FIG. 2 is a block diagram 200 of an audio module 170 according to an embodiment of the disclosure.

Referring to FIG. 2, the audio module 170 may include, for example, an audio input interface 210, an audio input mixer 220, an analog to digital converter (ADC) 230, an audio signal processor 240, a digital to analog converter (DAC) 250, an audio output mixer 260, or an audio output interface 270.

The audio input interface 210 is a part of an input module 150, and may receive an audio signal corresponding to sound obtained from the outside of the electronic device 101 via a microphone (e.g., a dynamic microphone, a condenser microphone, or a piezo microphone) configured separately from the electronic device 101. For example, when an audio signal is obtained from an external electronic device 102 (e.g., a headset or a microphone), the audio input interface 210 may be directly connected to the external electronic device 102 via a connection terminal 178 or in a wireless manner via a wireless communication module 192 (e.g., Bluetooth communication) so as to receive an audio signal. According to an embodiment, the audio input interface 210 may receive a control signal related to the audio signal acquired from the external electronic device 102 (e.g., a volume adjustment signal received via an input button). The audio input interface 210 may include a plurality of audio input channels, and may receive different audio signals from each corresponding audio input channel among the plurality of audio input channels. According to an embodiment, additionally or alternatively, the audio input interface 210 may receive an audio signal from another component of the electronic device 101 (e.g., the processor 120 or the memory 130).

The audio input mixer 220 may mix a plurality of input audio signals into at least one audio signal. For example, according to an embodiment, the audio input mixer 220 may mix a plurality of analog audio signals input via the audio input interface 210 into at least one analog audio signal.

The ADC 230 may convert an analog audio signal into a digital audio signal. For example, according to an embodiment, the ADC 230 may convert an analog audio signal received via the audio input interface 210, or may additionally or alternatively convert an analog audio signal mixed via the audio input mixer 220 into a digital audio signal.

The audio signal processor 240 may perform various processes on a digital audio signal received via the ADC 230 or a digital audio signal received from another component of the electronic device 101. For example, according to an embodiment, the audio signal processor 240 may perform changing of a sampling rate, application of one or more filters, interpolation, amplification or attenuation of all or some frequency bands, noise processing (e.g., noise or echo attenuation), channel changing (e.g., switching between mono and stereo), mixing, or extraction of a predetermined signal on one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from other components of the electronic device 101 (e.g., the processor 120 or the memory 130) into an analog audio signal.

The audio output mixer 260 may mix a plurality of input audio signals to be output into at least one audio signal. For example, according to an embodiment, the audio output mixer 260 may mix audio signals converted into analog audio signals via the DAC 250 and other analog audio signals (e.g., analog audio signals received via the audio input interface 210) into at least one analog audio signal.

The audio output interface 270 may output an analog audio signal converted via the DAC 250, or an analog audio signal additionally or substantially mixed by the audio output mixer 260 to the outside of the electronic device 101 via a sound output module 155. The sound output module 155 may include, for example, a speaker such as a dynamic driver or balanced armature driver, or a receiver. According to an embodiment, the sound output module 155 may include a plurality of speakers. In this case, the audio output interface 270 may output an audio signal having a plurality of different channels (e.g., stereo or 5.1 channels) through at least some of the plurality of speakers. According to an embodiment, the audio output interface 270 may be connected to the external electronic device 102 (e.g., an external speaker or a head set) directly via the connection terminal 178 or in a wireless manner via the wireless communication module 192 so as to output an audio signal.

According to an embodiment, the audio module 170 may not separately include the audio input mixer 220 or the audio output mixer 260, and may mix a plurality of digital audio signals by using at least one function of the audio signal processor 240 to generate at least one digital audio signal.

According to an embodiment, the audio module 170 may include an audio amplifier (not illustrated) (e.g., a speaker amplification circuit) capable of amplifying an analog audio signal input via the audio input interface 210 or an audio signal to be output through the audio output interface 270. According to an embodiment, the audio amplifier may be configured as a separate module from the audio module 170.

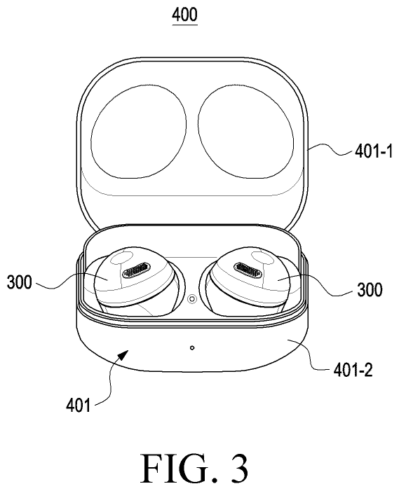

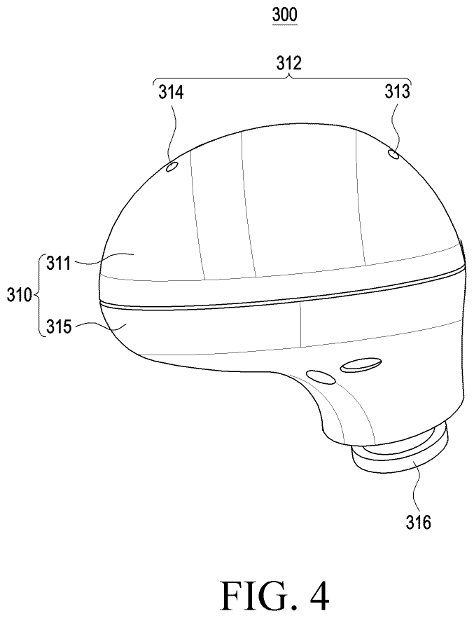

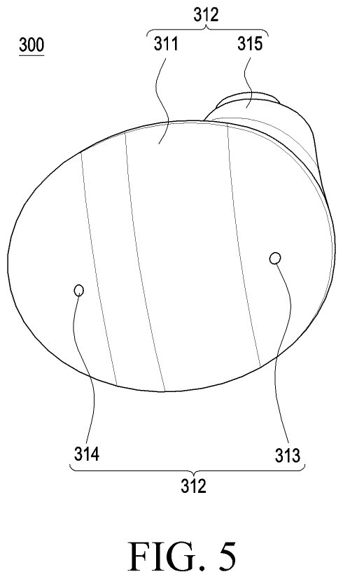

FIG. 3 is a view illustrating an implementation example of an electronic device according to an embodiment of the disclosure. FIG. 4 is a side view of a sound output device according to an embodiment of the disclosure. FIG. 5 is a top view of the sound output device according to an embodiment of the disclosure.

Referring to FIGS. 3 to 5, an electronic device 400 may include a cradle 401 and a sound output device 300 capable of being accommodated in the cradle 401. The description of the above-described electronic device (e.g., the electronic device 101 and/or the electronic device 102 in FIG. 1) may be applicable to the cradle 401 and the sound output device 300.

According to various embodiments, the term “cradle” 401 may mean an electronic device configured to accommodate the sound output device 300 or to charge the sound output device 300. Above and below in the disclosure, although the term “cradle” is used, but this is only for convenience of description and the spirit of the disclosure should not be interpreted as being limited to this term. In an embodiment, the cradle 401 may be opened or closed, and a user can store the sound output device 300 in a separate accommodation space formed in the cradle 401. The cradle 401 according to an embodiment may include a support portion 401-2 and an upper cover 401-1 disposed above the support portion 401-2 to shield at least a portion of the support portion 401-2. When the support portion 401-2 is shielded by the upper cover 401-1, the sound output device 300 may be prevented from being separated, and the inner space of the support portion 401-2 in which the sound output device 300 is accommodated may be provided as a sound chamber. In addition, in an embodiment, the cradle 401 may be electrically connected to the sound output device 300 to supply power to the sound output device 300 or transmit or receive an electrical signal. For example, the cradle 401 may identify the type of the sound output device 300 and transmit a signal to the sound output device 300 to adjust sound output configuration corresponding to the identified type. In the following description, for convenience of description, a signal for adjusting the sound output configuration of the sound output device 300 will be referred to as a “sound configuration signal”. The sound output device 300 may change the sound output configuration of the sound output device 300 in response to the received sound configuration signal. For example, the sound output device 300 may store various sound parameters that are capable of changing the sound output configuration corresponding to the sound configuration signal in separate internal memory. In some embodiments, the sound output device 300 may be directly controlled from the cradle 401 to change the sound output configuration of the sound output device 300. In addition, in some embodiments, the cradle 401 may be wirelessly connected to the sound output device 300 (e.g., by using BLE communication) and may transmit or receive an electrical signal wirelessly.

According to various embodiments, the sound output device 300 may include a housing 310 configured to accommodate components of the sound output device 300. For example, inside the housing 310, sound components (e.g., the audio module 170 in FIG. 2) and electronic components (e.g., the processor 120, the power management module 188, the battery 189, or the wireless communication module 192 in FIG. 1) may be arranged. The configuration of the sound output device 300 in FIGS. 4 and 5 may be substantially the same in whole or in part as that of the electronic device 101 in FIG. 1.

According to various embodiments, the sound output device 300 may include a wearable electronic device. For example, the sound output device 300 may be worn on a portion of a body such as an ear or a head. According to an embodiment, the sound output device 300 may include an in-ear earset, an in-ear headset, or a hearing aid.

According to various embodiments, referring to FIGS. 4 and 5, the sound output device 300 may have an asymmetric shape. According to an embodiment, since the sound output device 300 is configured to have an asymmetric shape, the sound output device 300 may be ergonomically designed, and may be improved in user convenience. According to an embodiment, since the sound output device 300 is configured to have an asymmetric shape, the sound components (e.g., the audio module 170 in FIG. 2) and electronic components (e.g., the processor 120 in FIG. 1) inside the housing 310 may be arranged to improve sound performance.

According to various embodiments, the sound output device 300 may be electrically connected to an external electronic device (e.g., the electronic device 102 in FIG. 1). According to an embodiment, the sound output device 300 may function as an audio output interface (or, for example, the sound output module 155 in FIG. 1) that outputs a sound signal received from the external electronic device 102 to the outside.

Additionally or alternatively, the sound output device 300 disclosed herein may function as an audio input interface (or the input module 150 in FIG. 1) for receiving an audio signal corresponding to sound acquired from the outside of the sound output device 300.

According to an embodiment, the sound output device 300 may communicate with and/or be controlled by the external electronic device 102. The sound output device 300 may be an interaction-type electronic device that is paired with an external electronic device such as a smartphone via a communication scheme, such as Bluetooth, and converts data received from the external electronic device 102 to output sound or receives a user's voice to transmit the voice to the external electronic device 102.

According to an embodiment, the sound output device 300 may be wirelessly connected to the external electronic device 102. For example, the sound output device 300 may communicate with the external electronic device 102 via a network (e.g., a short-range wireless communication network or a long-range wireless communication network). The network may include, but is not limited to, a mobile or cellular network, a local area network (LAN) (e.g., Bluetooth communication), a wireless local area network (WLAN), a wide area network (WAN), the Internet, or a small area network (SAN). According to an embodiment, the sound output device 300 may be connected to the external electronic device 102 in a wired manner by using a cable (not illustrated).

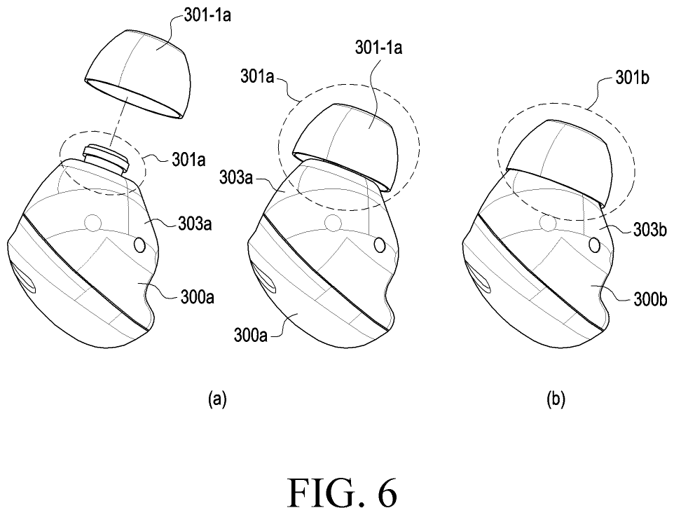

In the following description of the disclosure, the sound output device 300 may be classified into various types (e.g., a first type and a second type). As an example, the first type may be a kernel-type in-ear earset mainly configured to be mounted in an external auditory canal extending from an auricle to an eardrum. As another example, the second type may be an open-type earset configured to be mounted on an auricle. In an embodiment, the first type sound output device 300a may be classified depending on the shape or specification of the sound output portion (e.g., the sound output portion 301a in FIG. 6). In an embodiment, the first type sound output device 300a may be classified depending on the size of the ear tip (e.g., 301-1a). For example, the first type sound output device 300a may be classified depending on the size of the ear tip 301-1a. The size of the ear tip 301-1a may be expressed as the specification of the ear tip 301-1a. In other words, the sound output device 300 according to various embodiments may be classified into a first type (e.g., a kernel type) or a second type (e.g., an open type), and the first type sound output device 300a may be classified depending on the size or specification of the sound output portion 301a (e.g., the ear tip 301-1a). In addition, of course, the second type 300b may also be classified depending on the shape or specification of the sound output portion 301b. However, without being limited thereto, the term “type” in the disclosure may mean various criteria for changing the sound output configuration of a sound output device (e.g., the sound output device 300 in FIG. 3). For example, the term “type” in the disclosure should be understood as a comprehensive concept that includes all of the shape of the sound output device 300, the shape of the sound output portion (e.g., the sound output portion 301a in FIG. 6), and the size or specification of the ear tip (e.g., the ear tip 301-1a in FIG. 6). This will be described later. Descriptions related to the type of the sound output device 300 will be described later with reference to FIGS. 6 to 8.

According to various embodiments, the housing 310 may include a plurality of components. For example, the housing 310 may include a first housing 311 and a second housing 315 connected to the first housing 311. According to an embodiment, the first housing 311 and the second housing 315 may define at least a portion of the exterior of the sound output device 300 and define an inner space in which the components of the sound output device 300 are accommodated. According to an embodiment, in a state in which a user wears the sound output device 300, at least a portion of the second housing 315 comes into contact with or faces the user's body (e.g., an ear), and at least a portion of the first housing 311 may face away from the user.

According to various embodiments, the housing 310 may include a microphone hole 312. According to an embodiment, the microphone hole 312 may be interpreted as a through hole formed in the first housing 311. According to an embodiment, sound outside the sound output device 300 may pass through the microphone hole 312 to be transmitted to a microphone module (e.g., the microphone module 330 in FIG. 6) located inside the sound output device 300. According to an embodiment, the microphone hole 312 may include a plurality of microphone holes 313 and 314. For example, the microphone hole 312 may include a first microphone hole 313 and/or a second microphone hole 314 spaced apart from the first microphone hole 313.

According to various embodiments, the housing 310 may include a protrusion 316. According to an embodiment, at least a portion of the protrusion 316 may be inserted into a user's body (e.g., an ear). For example, the electronic device 400 may be inserted into and mounted in a user's body (e.g., an external auditory canal or an auricle of the body) by using the protrusion 316. According to an embodiment, the protrusion 316 may be interpreted as a portion of the housing 310 extending from the second housing 315. According to an embodiment, an ear tip (not illustrated) may be additionally mounted on the protrusion 316, and the electronic device 400 may be in close contact with the user's ear by using the ear tip. According to an embodiment, the protrusion 316 may include at least one recess (not illustrated), and sound output from a speaker module (e.g., the audio module 170 in FIG. 2) arranged inside the electronic device 400 may be emitted to the outside of the electronic device 400 via the recess located in the protrusion 316.

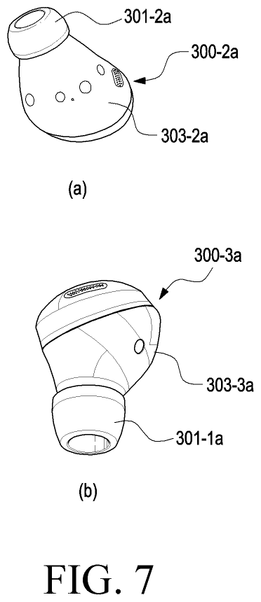

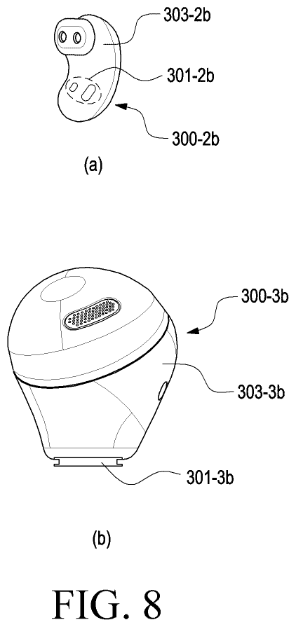

FIG. 6 is a view illustrating an example of first type sound output devices according to an embodiment of the disclosure. FIG. 7 is a view illustrating an example of first type sound output devices according to an embodiment of the disclosure. FIG. 8 is a view illustrating an example of second type sound output devices according to an embodiment of the disclosure.

Referring to FIGS. 6 to 8, the sound output device 300 may be classified into a first type sound output device 300a and/or a second type sound output device 300b. The description of the sound output device 300 of FIG. 5 may be applicable in whole or in part to the sound output device 300 of FIGS. 6 to 8.

According to various embodiments, the first type 300a and the second type 300b may be classified depending on the position of a user's body where the sound output device 300 is worn. As an example, the first type 300a may be a kernel-type in-ear earset mainly configured to be mounted in an external auditory canal extending from an auricle to an eardrum. As another example, the second type 300b may be an open-type earset configured to be mounted on an auricle.

According to various embodiments, the first type 300a and the second type 300b may be classified depending on whether or not an ear tip is installed. For example, the first type 300a may include, in the sound output portion 301a of the sound output device 300, an eartip 301-1a to be inserted into a user's external auditory canal. The second type 300b may not include a separate eartip (e.g., the eartip 301-1a of the first type) to be mounted on a user's auricle. As another example, the second type 300b may include, on the sound output portion 301b, an eartip (not illustrated) to be mounted on a user's auricle. In this case, the eartip (not illustrated) mounted on the second type 300b may have a different shape from the eartip 301-1a mounted on the first type 300a.

According to various embodiments, the first type 300a and the second type 300b may be classified depending on the shape of the sound output portion 301a or 301b. For example, the first type 300a may be configured such that the sound output portion 301a protrudes from the body 303a. Accordingly, at least a portion of the protruding sound output portion 301a of the first type 300a may be mounted in a user's external auditory canal. As another example, the second type 300b may have a shape in which the sound output portion 301b protrudes less from the body 303b than that of the first type 300a. Accordingly, the sound output portion 301b may be mounted on a user's auricle.

However, as described above, the classification of the first type 300a and the second type 300b are not limited to the above-described examples. For example, the first type and the second type may be simply classified based on the specification or size of the sound output portion 301. Even with a slight change in the size of the sound output portion 301, the quality of sound felt by a user may change, and the sound output configuration of the sound output device 300 need to be changed correspondingly. Therefore, in the following description of the disclosure, for convenience of description, the first type 300a will be mainly described as a kernel-type earset, and the second type 300b will be described as an open-type earset. However, the term “type” in the disclosure should be interpreted as a comprehensive concept that means various criteria (e.g., the shape or specification of the sound output portion) for changing the sound output configuration suitable for a user.

As an example, referring to FIG. 7, it is illustrated that the first types 300-2a and 300-3a according to various embodiments may have a sound output portion 301-2a or 301-2a extending from each of the bodies 303-2a and 303-3a by a predetermined length or more, or be mounted with a separate ear tip.

According to various embodiments, the ear tip 301-1a may provide various sounds to a user depending on the shape or specification thereof. For example, as the size of the ear tip 301-1a (e.g., the diameter of the ear tip 301-1a) increases, the sound output device 300 may come into closer contact with a user's external auditory canal and reduce external noise being transmitted to the user. Depending on the size of the ear tip 301-1a, the sound quality felt by the user or the fit felt in the external auditory canal may vary. Thus, it may be necessary to change the sound output configuration of the sound output device 300 depending on the size of the ear tip 301-1a.

As an example, referring to FIG. 8, it is illustrated that the second types 300-2b and 300-3b may have sound output portions 301-2b and 301-3b protruding by a predetermined length or less from the bodies 303-2b and 303-3b, respectively, to be worn on a user's ear. Alternatively, although not illustrated, a sound output portion may not protrude but may be parallel to or concave in one area of the body.

However, it will be understood that FIGS. 7 and 8 merely illustrates some of the various embodiments as examples, and that the spirit of the disclosure should not be interpreted as being limited to these examples.

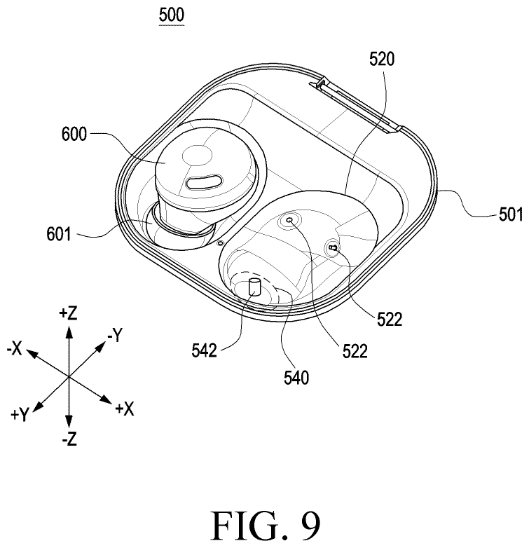

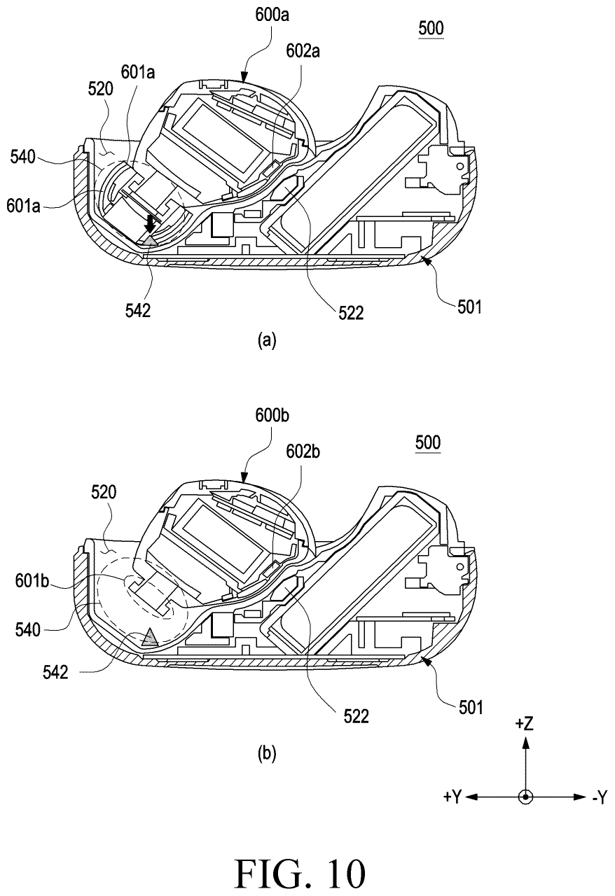

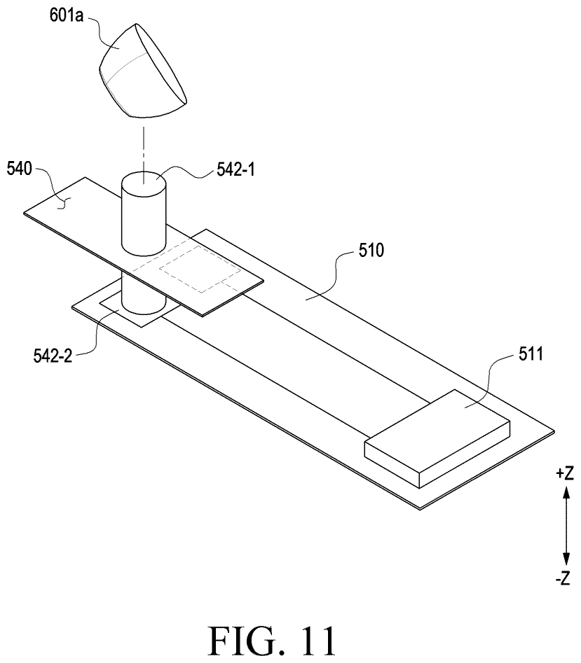

FIG. 9 is a view illustrating a sound output device disposed in a cradle according to an embodiment of the disclosure. FIG. 10 is a cross-sectional view illustrating various types of sound output devices disposed in the cradle according to an embodiment of the disclosure. FIG. 11 is a view illustrating an implementation example of a sensor module according to an embodiment of the disclosure.

Referring to FIGS. 9 to 11, an electronic device 500 according to the first embodiment may include a cradle 501 and a sound output device 600. The description of the electronic device (e.g., the electronic device 400 in FIG. 3) in the above-described embodiments may be applicable to the electronic device 500 of FIGS. 9 to 11. In addition, the descriptions of the cradles (e.g., the cradle 401 in FIG. 3) and the sound output devices (e.g., the sound output device 300 in FIG. 3) in the above-described embodiments may be applicable to the cradle 501 and the sound output device 600 in FIGS. 9 to 11.

According to various embodiments, the cradle 501 may include a mounting area 520 on which the sound output device 600 is placed. For example, the sound output device 600 may be placed in the mounting area 520 and stored together with the cradle 501. In an embodiment, contact terminals 522 may be placed in the mounting area 520. For example, the cradle 501 may be electrically connected to the sound output device 600 via the contact terminals 522, and the sound output device 600 are capable of receiving power or an electrical signal from the cradle 501. To this end, the sound output device 600 may also include a separate contact portion (e.g., the contact portion 602a in FIG. 10). In an embodiment, the cradle 501 may determine whether the sound output device 600 is seated therein via the contact terminals 522. For example, when the contact terminals 522 and the contact portion (e.g., the contact portion 602a and/or 602b in FIG. 10) of the sound output device 600 are connected, the cradle 501 may detect that the sound output device 600 is placed in the mounting area 520. As an example, the cradle 501 may detect a change in charging current transmitted to the sound output device 600 and determine whether the sound output device 600 is mounted on the cradle 501. As another example, the cradle 501 may determine whether the sound output device 600 is placed in the cradle 501 by using power line communication. In addition, the cradle 501 may determine whether the sound output device 600 is placed inside the cradle 501 through various methods.

According to various embodiments, the cradle 501 may include a detection area 540 disposed adjacent to the mounting area 520. In an embodiment, the detection area 540 may refer to a partial area of the mounting area 520. For example, the detection area 540 may be a portion of the mounting area 520 where the sound output portion 601 of the sound output device 600 is disposed.

According to various embodiments, the cradle 501 may include a sensor module 542. According to an embodiment, the sensor module 542 may be placed in the mounting area 520 or the detection area 540. According to an embodiment, the sensor module 542 may identify the type of the sound output device 600 placed in the cradle 501. For example, the sensor module 542 may detect the approach or contact of the sound output device 600 and detect the shape or type of the sound output portion 601.

In various embodiments of the disclosure, the sensor module 542 may be implemented in various ways. In an embodiment, the sensor module 542 may be implemented as a contact-type sensor that is capable of identifying the type of the sound output device 600 depending on whether the sensor module 542 is in contact or non-contact with the sound output device 600. For example, the sensor module 542 may identify the type of the sound output device 600 through a change in an electrical characteristic (e.g., the current value flowing through the sensor module) that occurs when the sensor module is in contact with the sound output device 600. As another example, one of a tactile switch, a force touch sensor, a Hall IC sensor, or a time of flight (TOF) sensor may be used. Various other embodiments and modifications are possible.

In various embodiments (see FIGS. 9 to 11), the sensor module 542 may be implemented as a contact sensor. The sensor module 542 may have an elastic material or shape. For example, the sensor module 542 may include a spring.

In an embodiment (referring to part (a) of FIG. 10), when the first type sound output device 600a is seated in the cradle 501, the sensor module 542 may be in contact with at least a portion of the sound output portion 601a or may be pressed by at least a portion of the sound output portion 601a. For example, the sensor module 542 may determine whether the first type sound output device 600a is the first type 600a by detecting whether at least a portion of the sound output portion 601a is in contact with the sensor module 542 or the sensor module 542 is pressed by the sound output portion 601a.

According to various embodiments, the cradle 501 may determine information about the shape (size or specification) of the sound output portion 601a of the first type sound output device 600a. For example, as described above, depending on the size of the sound output portion 601a (e.g., an ear tip), the degree to which the sensor module 542 is pressed or the change in the electrical signal applied to the sensor module 542, the cradle 501 may determine information about the size of the sound output portion 601a.

In an embodiment (referring to part (b) of FIG. 10), when the second type sound output device 600b is seated in the cradle 501, the sensor module 542 and the sound output portion 601b may be spaced apart from each other. For example, when the cradle 501 detects that the second type sound output device 600b is mounted on the cradle 501 in a state in which no object is in contact with the sensor module 542, the cradle 501 may determine that the second type sound output device 600b is the second type 600b.

Referring to FIG. 11, the sensor module 542 may be electrically connected to a circuit board 510 and a processor 511 disposed on the circuit board 510. In an embodiment, the sensor module 542 may include a contact portion 542-1 and a conductive portion 542-2. The conductive portion 542-2 may be electrically connected to the processor 511. The contact portion 542-1 may be disposed above the mounting area 540 (in the +Z-axis direction), and the conductive portion 542-2 may be disposed below the mounting area 540 (in the −Z-axis direction). When the sound output portion 601a comes into contact with the contact portion 542-1 or presses the contact portion 542-1 in the first direction (the −Z-axis direction), the contact portion 542-1 may move in the first direction (the −Z-axis direction) to come into contact with the conductive portion 542-2. When the contact portion 542-1 comes into contact with the conductive portion 542-2, the characteristic of an electrical signal (e.g., current) transmitted to the processor 511 changes, and based on this, the processor 511 may determine that the sound output device 600 is the first type 600a. As another example, when there is no change in the characteristic of the electrical signal transmitted to the processor 511 even though the sound output device 600 is mounted on the cradle 501, the processor 511 may determine that the sound output device 600 is the second type 600b based on this.

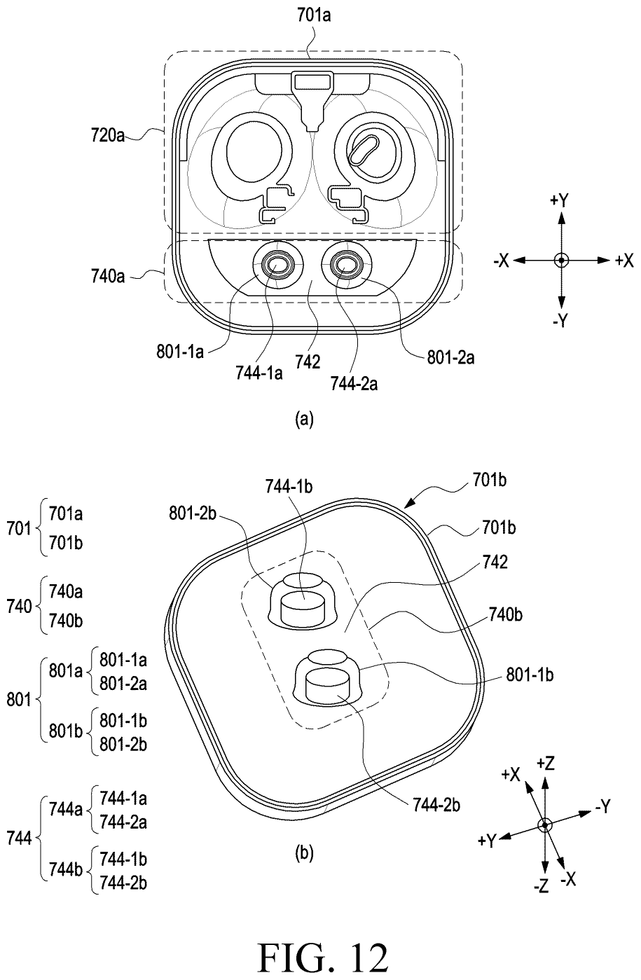

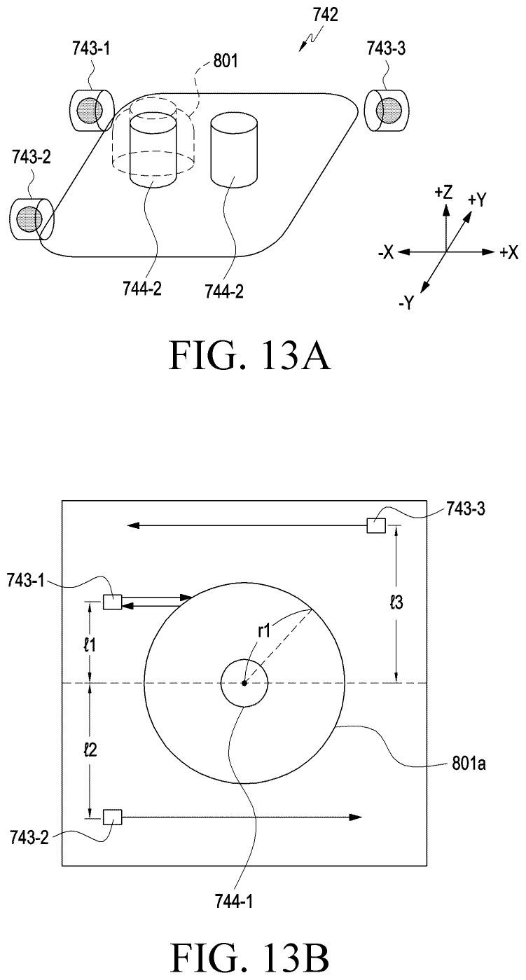

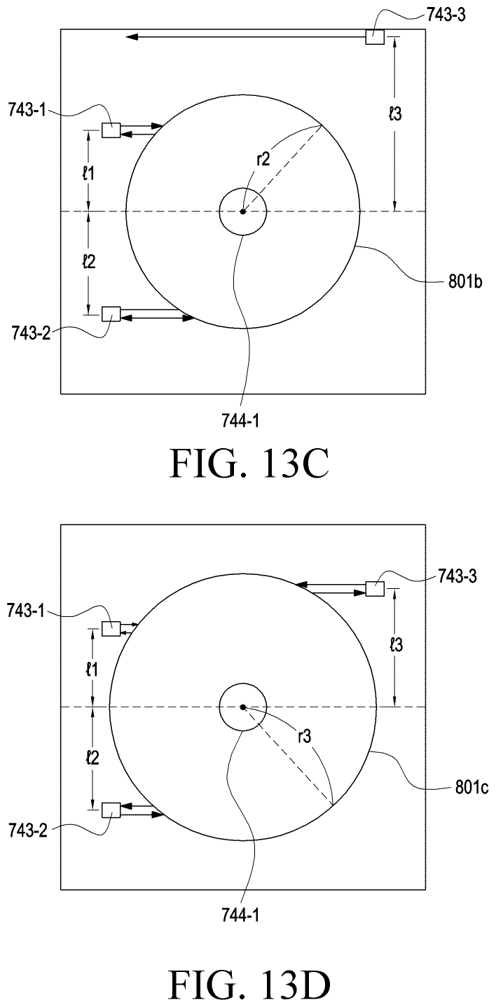

FIG. 12 is a view illustrating a cradle according to an embodiment of the disclosure. FIG. 13A is a view illustrating an implementation example of a sensor module according to an embodiment of the disclosure. FIG. 13B is a view illustrating another implementation example of the sensor module according to an embodiment of the disclosure. FIG. 13C is a view illustrating another implementation example of the sensor module according to an embodiment of the disclosure. FIG. 13D is a view illustrating another implementation example of the sensor module according to an embodiment of the disclosure.

Referring to FIGS. 12 and 13A to 13D, the cradle 701 may include a mounting area 720 and a detection area 740. The descriptions of the cradle 501 and the sound output device 600 in the above-described embodiments may be applicable to the cradle 701 and the sound output device 800 in FIGS. 12 and 13A to 13D.

According to various embodiments, the cradle 701 may identify the type of the sound output device (e.g., the sound output device 600 in FIG. 9) and acquire information related to the shape of the ear tip 801. In an embodiment, the cradle 701 may include a mounting area 720 in which the body (e.g., the body 303a in FIG. 6) of the sound output device 600 is to be mounted, and a detection area 740 disposed around the mounting area 720 configured to accommodate an ear tip 801-1a detachably mounted on the sound output device 600. The detection area 740 may be referred to as an “accommodation area” since it accommodates the ear tip 801. In an embodiment, the detection area 740 may be provided separately from the mounting area 720 and accommodate only the ear tip 801 separately from the body (e.g., the body 303a in FIG. 6). For example, a seating portion 744 where the ear tip 801 is to be seated may be disposed in the detection area 740, and the ear tip 801 may be seated on the seating portion 744. In the above and below descriptions of the disclosure, the ear tip 801 may include a pair of ear tips (e.g., 801-1a and 801-2a, or 801-1b and 801-2b), but for convenience of description, only one ear tip 801-1a or 801-1b among the pair of ear tips will be described. Similarly, the seating portion 744 may also include a pair of seating portions 744a (i.e., 744-1a and 744-2a) or 744b (744-1b and 744-2b), but for convenience of description, only one of the pair of seating portions 744-1a or 744-1b will be described.

In an embodiment, referring to part (a) of FIG. 12, the detection area 740a may be arranged in parallel to the mounting area 720a. The detection area 740a and the mounting area 720a may be described as being provided in parallel to a horizontal direction (e.g., the X-Y plane relative to the cradle 701 depicted as 701a in part (a) of FIGS. 12 and 701b in part (b) of FIG. 12). As another example, referring to part (b) of FIG. 12, the detection area 740b may be disposed to face the mounting area (e.g., the mounting area 720a in part (a) of FIG. 12). As another example, the mounting area (e.g., the mounting area 720a in part (a) of FIG. 12) may be described as being provided to be oriented in a first direction (the −Z-axis direction) in at least a portion of the cradle 701, and the detection area 740b may be described as being provided to be oriented in a second direction (the +Z-axis direction) in at least a portion of the cradle 701.

According to various embodiments, the sensor module 742 may be placed in the detection area 740. In an embodiment, at least a portion of the sensor module 742 (e.g., the seating portion 744) may be disposed to protrude from at least a portion of the detection area 740. For example, the ear tip 801 may be placed to be inserted into at least a portion of the sensor module 742, and the sensor module 742 may determine that the sound output device 800 is the first type (e.g., a kernel-type type in which an ear tip is detachably mounted) by detecting the placement of the ear tip 801.

According to various embodiments, when the ear tip 801 is placed in the detection area 740, the sensor module 742 may acquire information about the shape of the ear tip 801 (e.g., the size or specification of the ear tip 801). In various embodiments, the ear tip 801 to be detachably mounted on the sound output device 800 may have various shapes (or specifications), and a user may enjoy sounds with various characteristics corresponding to the shape of the ear tip 801. The cradle 701 according to various embodiments may acquire information about the shape of the ear tip 801, transmit a sound parameter corresponding to the shape of the ear tip 801 to the sound output device 800, or transmit a signal for changing the sound parameter output from the sound output device 800 to the sound output device. Alternatively, the cradle 701 may directly change a configured value of the sound output device 800 to output sound corresponding to the shape of the ear tip 801.

According to various embodiments (referring to FIGS. 13A to 13D), the sensor module 742 may include a plurality of optical sensors 743. As an example, the sensor module 742 may include an IR sensor array. In an embodiment, the sensor module 742 may include a first sensor 743-1, a second sensor 743-2, and a third sensor 743-3. However, without being limited thereto, the sensor module include two or four or more optical sensors.

In some embodiments, the sensor module 742 may measure the size of the ear tip 801 by measuring the time of flight (TOF) of light reflected from the ear tip 801. In this case, the sensor module 742 may include only a single optical sensor (e.g., 742-1).

According to various embodiments, the sensor module 742 may include a plurality of optical sensors 743 and a seating portion 744 where the ear tip 801 is to be seated.

According to various embodiments, the first to third sensors 743-1, 743-2, and 743-3 may be arranged horizontally (in the X-axis direction) and/or vertically (in the Y-axis direction) to be spaced apart from the seating portion 744 by a predetermined distance. For example, the first sensor 743-1 may be arranged to be spaced apart from the first seating portion 744-1 by a first distance 11 in the vertical direction (the Y-axis direction). The second sensor 743-2 may be arranged to be spaced apart from the first seating portion 744-2 by a second distance 12 in the vertical direction (the Y-axis direction). The third sensor 743-3 may be arranged to be spaced apart from the first seating portion 744-3 by a third distance 13 in the vertical direction (the Y-axis direction). In addition, the first to third distances 11 to 13 may satisfy the following relationship: the first distance 11 is shorter than the second distance 12, and the second distance 12 is shorter than the third distance 13.

According to an embodiment, the ear tip 801 may have different specifications depending on its size. In an embodiment illustrated as an example, the ear tips 801a, 801b, and 801c may each have a first radius r1 having a predetermined length range, a second radius r2 having another predetermined length range, or a third radius r3 having another predetermined length range.

According to various embodiments, with reference to the relationships of the first distance 11, the second distance 12, and the third distance 13, of the diameter or radius of the ear tip 801 placed in the seating portion 744 (e.g., the first radius r1, the second radius r2, and the third radius r3), the sensor module 742 may determine the specification of the ear tip 801.

For example, when the first radius r1 is larger than the first distance 11 and smaller than the second distance 12 (as another example, when the first sensor 743-1 and the first seating portion 744-1 are arranged such that the first distance 11 is smaller than the first radius r1 and the second distance 12 is larger than the first radius r1), only the light emitted from the first sensor 743-1 may be blocked (overlapped) by the ear tip 801a, and the light emitted from the second sensor 743-2 and the third sensor 743-2 may not reach the ear tip 801a. Accordingly, the sensor module 742 may determine that the ear tip 801a has the first radius r1.

As another example, when the first to third sensors 743-1, 743-2, and 743-3 and the first seating portion 744-1 are arranged such that the first distance 11 and the second distance 12 are smaller than the second radius r2 and the third distance 13 is larger than the second radius r2, the light emitted from the first sensor 743-1 and the second sensor 743-2 may be blocked by the ear tip 801b, and the light emitted from the third sensor 743-3 may not reach the ear tip 801a. Accordingly, the sensor module 742 may determine that the ear tip 801a has the second radius r2.

As another example, when the first to third sensors 743-1, 743-2, and 743-3, and the first seating portion 744-1 are arranged such that all of the first distance 11, the second distance 12, and the third distance 13 are smaller than the third radius r3, all light emitted from the first to third sensors 743-1, 743-2, and 743-3 may be blocked by the ear tip 801c, and the sensor module 742 may determine that the ear tip 801c has the third radius r3.

According to various embodiments, the sensor module 742 (e.g., the seating portion 744) may include a separate identification module (not illustrated) for determining the shape of the ear tip 801. For example, each ear tip 801 according to various embodiments may have an identifier (ID) containing information related to its shape, respectively, and the identification module may analyze the identifier and identify information the shape of the ear tip 801 interlocked with the sensor module 742 (for example, placed on the seating portion 744). As an example, the identification module may be implemented in a radio-frequency identification (RFID) type. For example, the ear tip 801 may be implemented as an RFID tag and the identification module (e.g., the identification module placed the seating portion 744) may be implemented as an RFID reader. However, this is merely one of various embodiments of the disclosure, and the identification module is not to be interpreted as being limited to the above-described examples.

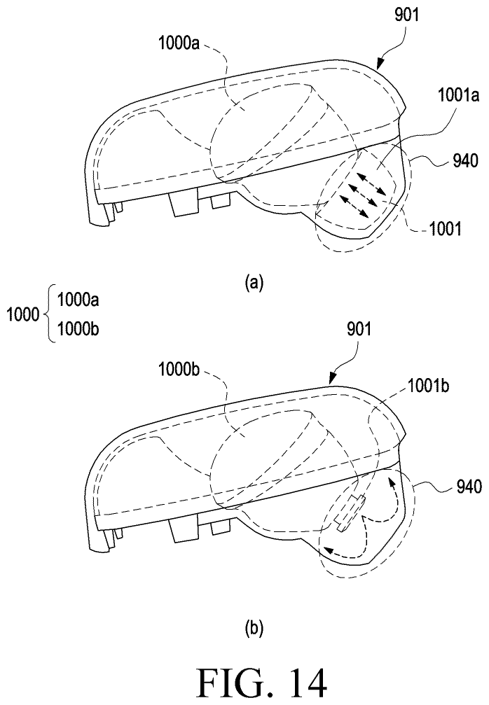

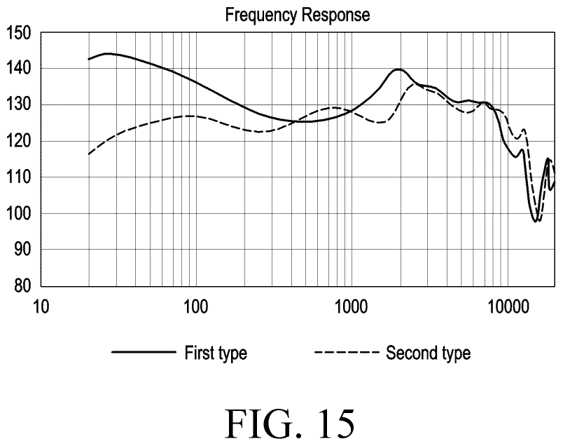

FIG. 14 is a view illustrating a sound output device disposed in a cradle according to an embodiment of the disclosure. FIG. 15 is a diagram showing the frequency characteristics of sound measured in the detection area depending on the types of sound output devices according to an embodiment of the disclosure.

Referring to FIGS. 14 and 15, the cradle 901 according to the third embodiment may include a detection area 1040 configured to detect sound emitted from the sound output device 1000. The descriptions of the cradles (e.g., the cradle 501 in FIG. 9 and/or the cradle 701 of FIG. 12) and the sound output devices (e.g., the sound output device 600 in FIG. 9) in the above-described embodiments may be applicable to the cradle 901 and the sound output device 1000 in FIG. 14.

According to various embodiments, the cradle 901 may measure the sound emitted from the sound output device 1000 in the detection area 940 and determine the type of the sound output device 1000 based on the characteristic of the measured sound. In an embodiment, a sensor module may be placed adjacent to the detection area 940. For example, the sensor module may be provided as a sound detection module (e.g., a microphone) configured to detect sound output 1001 from the first type sound output device 1001a or the second type sound output device 1000b.

In an embodiment, when the cradle 901 is in the closed state, the inside of the cradle 901 is closed, and the detection area 940 may be provided as a sound chamber that is capable of measuring the sound emitted from the sound output device 1000. In addition, depending on the type of the sound output device 1000, the frequency characteristic of the sound measured in the detection area 940 may change. In an embodiment, the cradle 901 may determine the type of the sound output device 1000 based on whether there is sound loss in a low-frequency band. In an embodiment, the cradle 901 may detect the switching of the cradle 901 to the closed state and control the sound output device 1000 to generate low-frequency sound correspondingly. The cradle 901 may control the sound output device 1000 to output sound in a low-frequency band based on whether an upper cover (e.g., the upper cover 401-1 in FIG. 3) closes a support portion (e.g., the support portion 401-2 in FIG. 3) or is in contact with the support portion (e.g., the support portion 401-2 in FIG. 3). For example (referring to part (a) of FIG. 14 and FIG. 15), when the sound output device 1000 is implemented as the first type 1000a, the free space of the detection area 940 may be narrowed, and the sound in the low-frequency band (e.g., about 20 to 300 kHz) may be detected to be higher than when the sound output device 1000 is implemented in the second type 1000b. As another example (referring to part (b) of FIG. 14 and FIG. 15), when the sound output device 1000 is implemented in the second type 1000b, the free space of the detection area 940 is expanded to correspond to the shape of the second type sound output portion 1000b, and the sound in the low-frequency band (e.g., about 20 to 300 Hz) can be detected to be lower than when the sound output device 1000 is implemented in the first type 1000a. Accordingly, the cradle 901 may identify the type of the sound output device 1000 based on differences in sound characteristic (e.g., the sound level depending on a frequency) measured in the detection area 940.

In another embodiment, the cradle 901 may determine the type of sound output device 1000 based on the sound level measured in a predetermined frequency range. As an example, the predetermined frequency range may be a low-frequency range (e.g., about 20 to 300 kHz). In addition, the cradle 901 may obtain information on the sound level output from the sound output device 1000 and compare this with the sound level detected in the detection area 940. For example, when the ratio of the sound level detected in the detection area 940 to the sound level output from the sound output device 1000 is equal to or lower than a threshold in the predetermined frequency range, the cradle 901 may determine the sound output device 1000 to be the second type 1000b. As another example, when the ratio of the sound level detected in the detection area 940 to the sound level output from the sound output device 1000 is equal to or higher than the threshold in the predetermined frequency range, the cradle 901 may determine the sound output device 1000 to be the first type 1000a.

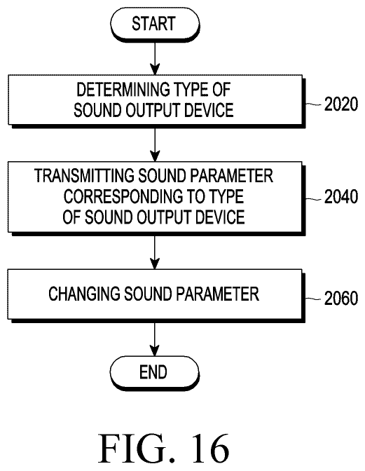

FIG. 16 is a flowchart illustrating a method of controlling sound output configuration by a sound output device in an electronic device according to an embodiment of the disclosure. In describing this embodiment, FIGS. 3 to 5 may be referred to together. However, the embodiment of this drawing is not limited to the electronic device 400 of FIGS. 3 to 5, and the descriptions related to the electronic devices, the cradles, or the sound output devices in the above-described embodiments may be applicable to the embodiment of this drawing.

Referring to FIG. 16, the method of controlling the sound output configuration of the sound output device may include an operation of determining the type of the sound output device at operation 2020, an operation of transmitting a sound configuration signal corresponding to the type of the sound output device at operation 2040, and an operation of changing a sound parameter at operation 2060.

According to various embodiments, an electronic device (e.g., the electronic device 400 in FIG. 3) may determine the type of a sound output device (2020). For example, the cradle 401 may determine the type of the sound output device 300 accommodated in the cradle 401. In some embodiments, the cradle 401 may determine that the sound output device is the second type when no ear tip is placed in the detection area (2020). In this case, the cradle 401 may transmit data (e.g., a sound parameter) corresponding to the second type to the sound output device (2040).

Regarding an example in which the cradle 401 determines the type of the sound output device 300, the above-described embodiments are applicable, and thus redundant descriptions will be omitted. In addition, as described above, like the cradle 701 according to the second embodiment, the cradle 701 may acquire information related to the shape of the ear tip 801.

When the type of the sound output device is determined, the electronic device 400 may select a sound configuration signal corresponding to the type of the sound output device at operation 2040. For example, when the sound output device is the first type, the cradle 401 may transmit a sound configuration signal corresponding to the first type to the sound output device. As another example, when the sound output device is the second type, the cradle 401 may transmit a sound configuration signal corresponding to the second type to the sound output device. In addition, as described above, the cradle 701 may transmit a sound setting signal related to the shape (e.g., size) of the ear tip 801 to the sound output device. In an embodiment, the cradle 401 may transmit the sound configuration signal to the sound output device in a wireless or wired manner.

In the above and below descriptions of the disclosure, the sound configuration signal should not be interpreted as containing only the information about the type of the sound output device 300. For example, the sound configuration signal may include a sensor signal based on a sensor module (e.g., the sensor module 542 in FIG. 9) according to various embodiments, and may also include information about the shape (size or specification) of the sound output portion (e.g., the ear tip), as will be described later. In addition, the sound configuration signal may include a trigger signal that instructs the processor of the sound output device 300 to change sound output configuration. In other words, the term “sound configuration signal” should be understood as having a concept that comprehensively includes various electrical signals transmitted from the cradle 401 to the sound output device 300.

When the sound configuration signal is transmitted, the electronic device 400 may change the sound output configuration of the sound output device at operation 2060. In an embodiment, the sound output device may change the sound output configuration of the sound output device to correspond to the sound configuration signal transmitted from the cradle 401. As an example, the sound output device 300 may delete a previously applied sound parameter and apply the sound parameter corresponding to the sound configuration signal transmitted via the cradle 401. As described above, the sound parameter may be stored in advance in the sound output device 300. In another embodiment, the cradle 401 may be electrically connected to the sound output device and directly change the sound output configuration of the sound output device.

In addition, when the configuration of the sound output device 300 is changed or when the sound output device 300 receives a sound parameter, the cradle 401 may determine whether the sound output device 300 is separated from the cradle 401. When the sound output device 300 is determined to be separated from the cradle 401, the cradle 401 may determine that the sound output device 300 is in use and switch the cradle 401 to a sleep state.

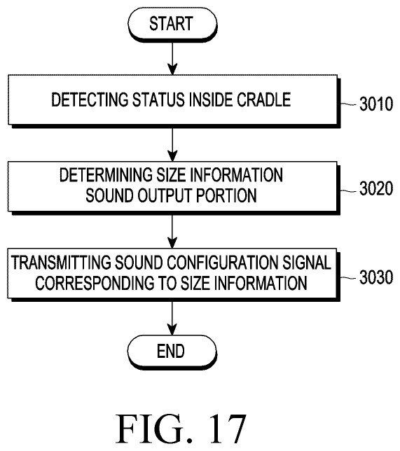

FIG. 17 is a flowchart illustrating a method of controlling configuration of a sound output device by a cradle according to an embodiment of the disclosure.

Referring to FIG. 17, the method of controlling the configuration of the sound output device by the cradle includes an operation of detecting the state within the cradle at operation 3010, an operation of determining size information of the sound output portion at operation 3020, and an operation of transmitting a sound configuration signal corresponding to the size information at operation 3030. In describing the method of FIG. 17, the description of the control method of FIG. 16 may also be applied. In addition, of course, the method of FIG. 17 may be provided in combination with the method of FIG. 16.

According to various embodiments, the cradle 401 may detect an internal status of the cradle 401 at operation 3010. In an embodiment, for example, when the sound output device is determined to be the first type in the method of FIG. 16, the cradle 401 may determine whether an ear tip is disposed inside the cradle 401. As described above with reference to FIG. 12, the cradle 401 may determine that only the ear tip is separately placed inside the cradle 401, or may determine that the ear tip is placed inside the cradle in the state of being mounted on the sound output device. For example, the cradle 401 may determine the shape of an ear tip (e.g., the ear tip 801 in FIG. 13A) disposed in a detection area (e.g., the detection area 740a or 740b in FIG. 9) provided in the cradle 401. In addition, as described above, the cradle 401 may determine, via the contact terminals (e.g., the contact terminals 522 in FIG. 9) whether the sound output device 300 is mounted within the cradle 401 or is in a state for transmitting an electrical signal.

In some embodiments, when no ear tip is placed in the detection area, the cradle 401 may determine that the sound output device is the second type and transmit data corresponding to the second type (e.g., a sound parameter) to the sound output device.

According to various embodiments, to correspond to the internal state of the cradle 401, the cradle 401 may determine size information of the sound output portion at operation 3020. For example, the cradle 401 may first determine the type of the sound output device 300 (e.g., the method of FIG. 16), then additionally acquire information related to the size of the ear tip (e.g., 301-1a, FIG. 6), and transmit an optimal sound configuration signal to the sound output device 300. Since the above-described descriptions may be applicable to various examples of determining the size information of sound output portions, redundant descriptions will be omitted.

When the size information of the sound output portion is determined, the cradle 401 may transmit a sound configuration signal corresponding to the size information to the sound output device 300 at operation 3030. For example, the sound configuration signal may be transmitted in a wired or wireless manner.

Various embodiments may provide an electronic device including a cradle (e.g., the cradle 401 in FIG. 3) including a mounting area configured such that a sound output device with a sound output portion at one side is detachably mounted, and a detection area, a circuit board disposed within the cradle and including a processor configured to control the sound output device, and a sensor module (e.g., the sensor module 542 in FIG. 9) disposed adjacent to the detection area and electrically connected to the processor. The sound output portion may be fabricated in at least one of a first type and a second type, the sensor module may be configured to transmit, to the processor, sensing information reflecting at least one of a contact state between the sound output portion and the sensor module based on the type of the sound output portion, an adjacent state between the sound output portion and the sensor module, or a state related to the type of the sound output portion, and the processor may be configured to transmit, based on the sensing information, a sound configuration signal for adjusting sound output configuration of the sound output device, to the sound output device.

An embodiment may provide the electronic device in which the first type includes a canal-type earset or a structure configured to be mounted in a user's external auditory canal, and the second type includes an open-type earset or a structure configured to be mounted on a user's auricle.

An embodiment may provide the electronic device in which the sensor module includes a spring, a pad, or a pogo pin to determine the contact state between the sound output portion and the sound output device.

An embodiment may provide the electronic device in which the sound output device includes a detachably attached ear tip on the sound output portion, and the ear tip is configured to be placed in the detection area.

An embodiment may provide the electronic device in which the sensor module is configured to obtain information related to a shape of the ear tip.

An embodiment may provide the electronic device in which the cradle is configured to transmit the sound configuration signal to the sound output device based on the information related to the shape of the ear tip obtained by the sensor module.

An embodiment may provide the electronic device in which the information related to the shape includes size information of the ear tip.

An embodiment may provide the electronic device in which the sound output device is configured to change the sound output configuration of the sound output device based on the sound configuration signal received from the cradle.

An embodiment may provide the electronic device in which the cradle includes a support portion on which the mounting area is provided and an upper cover connected to the support portion, and when the mounting area is shielded by the upper cover, the mounting area provides a shielded sound chamber within the cradle.

An embodiment may provide the electronic device in which the sensor module includes a sound detection module, and the processor is configured to transmit a signal to the sound output device such that the sound output device outputs sound in a designated frequency band when the mounting area is shielded by the upper cover, and to determine the type of the sound output device based on the sound measured by the sensor module.

An embodiment may provide the electronic device in which the cradle further includes a contact terminal disposed in the accommodation area and configured to be electrically connected to the sound output device.

An embodiment may provide the electronic device in which the cradle is configured to transmit the sound configuration signal to the sound output device via the contact terminal.

An embodiment may provide the electronic device in which the cradle is capable of wirelessly transmitting the sound parameter to the sound output device.

Various embodiments may provide a cradle control method for controlling a cradle configured to accommodate a sound output device in which the cradle control method include an operation of determining whether a sound output device is placed within a mounting area, an operation of identifying a type of an output portion provided in at least a portion of the sound output device, wherein the sound output portion has at least one of a first type and a second type and selects a sound configuration signal corresponding to the identified type of the sound output portion, and an operation of transmitting the selected sound configuration signal to the sound output device so as to control sound output configuration of the sound output module.

An embodiment may provide the cradle control method in which the first type includes a canal-type earset or a structure configured to be mounted in a user's external auditory canal, the second type includes an open-type earset or a structure configured to be mounted on a user's auricle, and at least one of the first type and the second type may be distinguishable depending on a specification of the sound output portion.

An embodiment may provide the cradle control method further including an operation of acquiring specification information regarding an ear tip configured to be detachably attached to the sound output device, and an operation of selecting a sound configuration signal corresponding to the specification information of the ear tip.

An embodiment may provide the cradle control method in which the identifying a type of a sound output portion provided in at least a portion of the sound output device comprises determining that the sound output device is the second type when no ear tip is placed in a detection area of the cradle and transmitting a sound parameter corresponding to the second type to the sound output device.

Various embodiments may provide one or more non-transitory computer-readable storage media storing one or more computer programs including computer-executable instructions that, when executed by one or more processors of an electronic device individually or collectively, cause the electronic device to perform operations. The operations comprises determining whether a sound output device is placed within a mounting area, identifying a type of a sound output portion provided in at least a portion of the sound output device, wherein the sound output portion has at least one of a first type or a second type, selecting a sound configuration signal corresponding to the identified type of the sound output portion and transmitting the selected sound configuration signal to the sound output device so as to control sound output configuration of the sound output device.

An embodiment may provide the One or more non-transitory computer-readable storage media further including an operation of acquiring specification information regarding an ear tip configured to be detachably attached to the sound output device, and an operation of selecting a sound configuration signal corresponding to the specification information of the ear tip.

An embodiment may provide the cradle control method in which the identifying a type of a sound output portion provided in at least a portion of the sound output device comprises determining that the sound output device is the second type when no ear tip is placed in a detection area of the cradle and transmitting a sound parameter corresponding to the second type to the sound output device.

Various embodiments may provide a sound output device including a housing (e.g., the body 303a in FIG. 6) including a sound output portion and defining the exterior of the audio output device, a contact portion (e.g., the contact portion 602a in FIG. 10) disposed in the housing and electrically connected to the cradle, and a circuit board disposed within the housing and including a processor configured to control the sound output device. The sound output portion may be fabricated in at least one of a first type and a second type, and the processor may be configured to receive a sound configuration signal corresponding to at least one of the first type or the second type from the cradle to change the sound output configuration of the sound output device.

An embodiment may provide a sound output device further including an ear tip disposed to be detachably attached to the sound output portion in which the processor is configured to receive a sound configuration signal corresponding to the shape of the ear tip from the cradle and change the sound output configuration of the sound output device.

An embodiment may provide a sound output device configured to receive the sound configuration signal from the cradle via the contact portion.

An embodiment may provide a sound output device further including a wireless communication module configured to be wirelessly connected to the cradle in which the sound output device is configured to receive the sound configuration signal from the cradle wirelessly.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a cradle comprising:
a mounting area configured such that a sound output device with a sound output portion at one side thereof is detachably mounted, and
a detection area;
a circuit board disposed within the cradle and comprising a processor configured to control the sound output device; and
a sensor module disposed adjacent to the detection area and electrically connected to the processor,
wherein the sound output portion is fabricated in at least one of a first type or a second type,
wherein the sensor module is configured to transmit, to the processor, sensing information reflecting at least one of a contact state between the sound output portion and the sensor module based on the at least one of the first type or the second type of the sound output portion, an adjacent state between the sound output portion and the sensor module, or a state related to the at least one of the first type or the second type of the sound output portion, and
wherein the processor is configured to transmit, based on the sensing information, a signal related to sound configuration for adjusting sound output configuration of the sound output device, to the sound output device.

2. The electronic device of claim 1,
wherein the first type comprises a canal-type earset or a structure configured to be mounted in a user's external auditory canal, and
wherein the second type comprises an open-type earset or a structure configured to be mounted on a user's auricle.

3. The electronic device of claim 1, wherein the sensor module comprises a spring, a pad, or a pogo pin to determine the contact state between the sound output portion and the sound output device.

4. The electronic device of claim 1,
wherein the sound output device comprises a ear tip on the sound output portion,
wherein the ear tip is detachable; and
wherein the ear tip is configured to be placed in the detection area.

5. The electronic device of claim 4, wherein the sensor module is configured to obtain information related to a shape of the ear tip.

6. The electronic device of claim 5, wherein the cradle is configured to transmit a signal related to the sound configuration to the sound output device based on the information related to the shape of the ear tip obtained by the sensor module.

7. The electronic device of claim 5, wherein the information related to the shape comprises size information of the ear tip.

8. The electronic device of claim 1, wherein the sound output device is configured to change the sound output configuration of the sound output device based on a signal related to the sound configuration received from the cradle.

9. The electronic device of claim 1, wherein the cradle comprises:
a support portion on which the mounting area is provided and an upper cover connected to the support portion, and
when the mounting area is shielded by the upper cover, the mounting area is provided as a shielded sound chamber within the cradle.

10. The electronic device of claim 9,
wherein the sensor module comprises a sound detection module, and
wherein the processor is configured to:
transmit a signal to the sound output device such that the sound output device outputs sound in a designated frequency band when the mounting area is shielded by the upper cover, and
determine a type of the sound output device based on the sound measured by the sensor module.

11. The electronic device of claim 1,
wherein the cradle further comprises a contact terminal disposed in the mounting area, and
wherein the cradle is configured to be electrically connected to the sound output device.

12. The electronic device of claim 11, wherein the cradle is configured to transmit a signal related to the sound configuration to the sound output device via the contact terminal.

13. The electronic device of claim 1, wherein the cradle is capable of wirelessly transmitting a sound parameter to the sound output device.

14. A method of controlling a cradle configured to accommodate a sound output device, the method comprising:
determining whether the sound output device is placed within a mounting area;
identifying a type of a sound output portion provided in at least a portion of the sound output device, wherein the sound output portion has at least one of a first type or a second type;
selecting a sound configuration signal corresponding to the identified type of the sound output portion; and
transmitting the selected sound configuration signal to the sound output device so as to control sound output configuration of the sound output device.

15. The method of claim 14,
wherein the first type comprises a canal-type earset or a structure configured to be mounted in a user's external auditory canal,
wherein the second type comprises an open-type earset or a structure configured to be mounted on a user's auricle, and
wherein at least one of the first type or the second type is configured to be distinguished depending on a specification of the sound output portion.

16. The method of claim 15, further comprising:
acquiring specification information regarding an ear tip configured to be detachably attached to the sound output device; and
selecting a sound configuration signal corresponding to the specification information of the ear tip.

17. The method of claim 15, wherein the identifying a type of a sound output portion provided in at least a portion of the sound output device comprises:
determining that the sound output device is the second type when no ear tip is placed in a detection area of the cradle; and
transmitting a sound parameter corresponding to the second type to the sound output device.

18. One or more non-transitory computer-readable storage media storing one or more computer programs including computer-executable instructions that, when executed by one or more processors of an electronic device individually or collectively, cause the electronic device to perform operations, the operations comprising:
determining whether a sound output device is placed within a mounting area;
identifying a type of a sound output portion provided in at least a portion of the sound output device, wherein the sound output portion has at least one of a first type or a second type;
selecting a sound configuration signal corresponding to the identified type of the sound output portion; and
transmitting the selected sound configuration signal to the sound output device so as to control sound output configuration of the sound output device.

19. The one or more non-transitory computer-readable storage media of claim 18, the operations further comprising:
acquiring specification information regarding an ear tip configured to be detachably attached to the sound output device; and
selecting a sound configuration signal corresponding to the specification information of the ear tip.

20. The one or more non-transitory computer-readable storage media of claim 19, wherein the identifying a type of a sound output portion provided in at least a portion of the sound output device comprises:
determining that the sound output device is the second type when no ear tip is placed in a detection area of a cradle; and
transmitting a sound parameter corresponding to the second type to the sound output device.
